(19) United States
(12) Patent Application Publication
(10) Pub. No.: US 2023/0174763 A1
(43) Pub. Date: Jun. 8, 2023

(54) ELASTOMER COMPOSITION AND SEALING MATERIAL COMPRISING SAME

(71) Applicant: MITSUBISHI CABLE INDUSTRIES, LTD., Tokyo (JP)

(72) Inventors: Hiroaki YASUDA, Amagasaki-shi (JP); Takao ITO, Amagasaki-shi (JP); Ryohei TAKEDA, Amagasaki-shi (JP); Takehiro HAMAMURA, Tokyo (JP)

(73) Assignee: MITSUBISHI CABLE INDUSTRIES, LTD., Tokyo (JP)

(21) Appl. No.: 17/920,002

(22) PCT Filed: Apr. 8, 2021
(86) PCT No.: PCT/JP2021/014937

§ 371 Date: Oct. 19, 2022

(30) Foreign Application Priority Data
Apr. 21, 2020 (JP) 2020-075483

(51) Int. Cl. C08L 27/16; C08K 3/36; C09K 3/10; F16J 15/10; C08L 83/04

(52) U.S. Cl. CPC C08L 27/16; C08K 3/36; C08L 83/04; C09K 3/1009; F16J 15/102; C08L 2312/00; C09K 2200/0247; C09K 2200/0637; C09K 2200/0672; C09K 2200/0685

(57) ABSTRACT

To achieve properties such as a desirable compression fracture property, desirable compression set, and the like in the elastomer composition and the seal material using same. The elastomer composition of the present disclosure therefore includes an elastomer, phenol resin in powder form, and silica in powder form. The seal material of the present disclosure is obtained by crosslinking and molding the elastomer composition of the present disclosure. The seal material may be used in a semiconductor manufacturing device.

### TECHNICAL FIELD

The present disclosure relates to an elastomer composition and a seal material made of same.

### BACKGROUND ART

Elastomer compositions having various properties are known and used for different purposes. For example, hardness, tensile strength, resistance to compression fracture, compression set, and the like are important in seal materials for obtaining airtightness in mechanical devices.

Patent Document 1 discloses enhancement of resistance to compression fracture by reducing the crosslink density of rubber. Patent Document 2 discloses enhancement of resistance to compression fracture by controlling the molecular weight of rubber.

### CITATION LIST

### Patent Documents

PATENT DOCUMENT 1: Japanese Unexamined Patent Publication No. 2010-235906
PATENT DOCUMENT 2: International Patent Publication No. WO 2003/074625

### SUMMARY OF THE INVENTION

### Technical Problem

It is desirable to prevent compression fracture in the seal material. Usually, when the seal material is used, compressibility is limited in order to avoid compression fracture. However, due to design matters, tolerance, expansion during heating, and the like, the compressibility may become larger than expected. In particular, at high temperatures, the coefficient of linear expansion of rubber increases, and the strength decreases, thereby being prone to compression fracture.

When the crosslink density of rubber is reduced to enhance resistance to compression fracture, the compression set decreases. Further, it is known that the resistance to compression fracture is enhanced by controlling the molecular weight of rubber. However, the molecular weight is determined during polymer polymerization. Thus, it is necessary to set conditions and the like of the polymerization for each purpose, which is inferior in terms of versatility.

The present disclosure is intended to achieve properties such as a desirable compression fracture property, desirable compression set, and the like in the elastomer composition and the seal material using same.

### Solution to the Problem

The elastomer composition of the present disclosure includes an elastomer, phenol resin in powder form, and silica in powder form. The seal material of the present disclosure is obtained by crosslinking and molding the elastomer composition of the present disclosure. Further, the seal material of the present disclosure is for use in a semiconductor manufacturing device.

### Advantages of the Invention

By using the elastomer composition of the present disclosure, an article having excellent resistance to compression fracture and excellent compression set can be manufactured.

### DESCRIPTION OF EMBODIMENT

An embodiment of the present disclosure will be described below. The elastomer composition of the present embodiment includes an elastomer, phenol resin in powder form, and silica in powder form. By using the elastomer composition including both phenol resin and silica, an article having excellent resistance to compression fracture and excellent compression set can be manufactured. The article can be, for example, a seal material for imparting airtightness to mechanical devices, particularly a seal material for use in a semiconductor manufacturing device.

The elastomer is desirably a fluorine elastomer and a silicone elastomer. The elastomer may consist of only one of them, or may contain both. The elastomer may further contain other types of elastomer in addition to these elastomers which are main components (50 mass% or more). In order to achieve excellent resistance to compression fracture and excellent compression set, the elastomer desirably contains a fluorine elastomer, more desirably consists of only a fluorine elastomer.

Examples of the fluorine elastomer include, for example, a copolymer (binary FKM) of vinylidene fluoride (VDF) and hexafluoropropylene (HFP), a copolymer (ternary FKM) of vinylidene fluoride (VDF), hexafluoropropylene (HFP), and tetrafluoroethylene (TFE), a copolymer (FEP) of tetrafluoroethylene (TFE) and propylene (Pr), a copolymer of vinylidene fluoride (VDF), propylene (Pr), and tetrafluoroethylene (TFE), a copolymer (ETFE) of ethylene (E) and tetrafluoroethylene (TFE), a copolymer of ethylene (E), tetrafluoroethylene (TFE), and perfluoromethyl vinyl ether (PMVE), a copolymer of vinylidene fluoride (VDF), tetrafluoroethylene (TFE), and perfluoromethyl vinyl ether (PMVE), a copolymer of vinylidene fluoride (VDF) and perfluoromethyl vinyl ether (PMVE), and a copolymer of tetrafluoroethylene (TFE) and perfluoroalkyl ether (PFAE). One kind or two or more kinds of these substances are used in one preferred embodiment.

Of the above-described substances, binary FKM, ternary FKM, FEPM, FFKM, and perfluoropolyether are more preferred.

As a method of crosslinking the fluorine elastomer, polyol crosslinking and peroxide (organic peroxide) crosslinking are known, and either of them can be used.

Polyol crosslinking is better than peroxide crosslinking in terms of the compression set. However, in the case of polyol crosslinking, HF is generated during crosslinking reaction, and for this reason, MgO, Ca(OH)₂, and the like need to be added for absorbing HF. As a result, a fluorine elastomer subjected to polyol crosslinking tends to contain a greater amount of metal and generate dust more easily under plasma environment, as compared to a fluorine elastomer subjected to peroxide crosslinking. For this reason, peroxide crosslinking is more suitable for the seal material for use in the semiconductor manufacturing device. Peroxide crosslinking is more suitable also in terms of chemical resistance and steam resistance (tending to be degraded due to the metal oxide). However, polyol crosslinking is not excluded because the fluorine elastomer subjected to polyol crosslinking also produces an improvement in the compression set when phenol resin powder is added to the fluorine elastomer.

Peroxide is a thermal crosslinking agent that crosslinks the rubber component when heated to a predetermined temperature. Specific examples include 1,1-bis(t-butyl peroxy)-3,5,5-trimethylcyclohexane, 2,5-dimethylhexane-2,5-dihydroperoxide, di-t-butyl peroxide, t-butyl cumyl peroxide, dicumyl peroxide, α,α-bis(t-butyl peroxy)-p-diisopropylbenzene, 2,5-dimethyl-2,5-di(t-butylperoxy)hexane, 2,5-dimethyl-2,5-di(t-butylperoxy)-hexyne-3, benzoyl peroxide, t-butyl peroxybenzene, t-butyl peroxymaleic acid, t-butyl peroxy isopropylcarbonate, and t-butyl peroxybenzoate. As peroxide, one kind or two or more kinds of these substances are used in one preferred embodiment. In order to obtain excellent physical properties, 2,5-dimethyl-2,5-di(t-butylperoxy)hexane is used in one more preferred embodiment.

Bisphenols are suitable as a polyol-based crosslinking agent. Specific examples include polyhydroxy aromatic compounds such as 2,2-bis(4-hydroxyphenyl)propane [bisphenol A], 2,2-bis(4-hydroxyphenyl)perfluoropropane [bisphenol AF], bis(4-hydroxyphenyl)sulfone [bisphenol S], bisphenol A-bis(diphenyl phosphate), 4-4′-dihydroxydiphenyl, 4,4′-dihydroxydiphenylmethane, and 2,2-bis(4-hydroxyphenyl)butane. In order to obtain excellent physical properties, bisphenol A, bisphenol AF, and the like are suitable as polyol. These substances may be in the form of alkali metal salt or alkali earth metal salt.

Examples of the silicone rubber include methyl vinyl silicone rubber, methyl vinyl phenyl silicone rubber, and fluoro silicone rubber. One kind or two or more kinds of these silicone rubbers are used in one preferred embodiment. Crosslinking of the silicone rubber may be performed by using organic peroxide, condensation polymerization, or using a platinum catalyst.

The phenol resin is used suitably in powder form. Specifically, the average particle size is desirably 20 µm or less, more desirably 10 µm or less, yet more desirably 6 µm or less. The average particle size refers to the 50% particle size measured by laser diffraction scattering method.

The phenol resin used in the present embodiment is preferably a phenol resin whose reaction has been completed. For example, a phenol resin, the extract of which after being heated and refluxed in methanol is 10% by mass or less is preferred. Phenol resin having a free phenol content of 500 ppm or less is preferred.

In order to improve the compression set, the amount of the phenol resin blended is preferably 1 part by mass or more, more preferably 3 parts by mass or more, yet more preferably 5 parts by mass or more relative to 100 parts by mass of the rubber component. For the same purpose, the amount of the phenol resin blended is preferably 30 parts by mass or less, more preferably 25 parts by mass or less, yet more preferably 15 parts by mass or less.

The silica is also used preferably in powder form. The silica preferably has a specific surface area measured according to the BET method of 90 m²/g or more. Silica is preferably synthetic amorphous silica, such as dry silica or wet silica, more preferably dry silica, such as hydrophilic dry silica or hydrophobic dry silica, and yet more preferably hydrophobic dry silica.

Silica may be subjected to surface treatment. For example, surface treatment using a silane coupling agent is performed to introduce a methyl group, a dimethyl group, a trimethyl group, and the like.

In order to improve the resistance to compression fracture, the amount of the silica blended is preferably 1 part by mass or more, more preferably 3 parts by mass or more, yet more preferably 5 parts by mass or more relative to 100 parts by mass of the rubber component. For the same purpose, the amount of the silica blended is preferably 30 parts by mass or less, more preferably 25 parts by mass or less, yet more preferably 15 parts by mass or less.

The fluorine-containing elastomer composition forming the seal material of the present embodiment may further contain a hydrogen site protecting agent. The hydrogen site protecting agent is a compound to be bonded to a carbon radical generated as a result of breakage of a carbon-hydrogen bond of the rubber component upon radiation emission during manufacture of the rubber product.

In one preferred embodiment, the hydrogen site protecting agent contains a compound having a perfluoro skeleton having an alkenyl group bonded to the carbon radical of the rubber component in a molecule and/or a compound having a siloxane skeleton having an alkenyl group bonded to the carbon radical of the rubber component in a molecule. Examples of the alkenyl group include a vinyl group, an allyl group, a butenyl group, a pentenyl group, a hexenyl group, and a heptenyl group. Among these alkenyl groups, the vinyl group is preferred.

Examples of the compound having the perfluoro skeleton having the alkenyl group in the molecule include a compound having a perfluoropolyether structure, and a compound having a perfluoroalkylene structure. Examples of the compound having the siloxane skeleton having the alkenyl group in the molecule include a polymer of methylvinylsiloxane, a polymer of dimethylsiloxane, a copolymer of dimethylsiloxane and methylvinylsiloxane, a copolymer of dimethylsiloxane, methylvinylsiloxane, and methylphenylsiloxane. Other examples include organopolysiloxane containing an alkenyl group in a molecule, such as addition-polymerized liquid silicone rubber. In one preferred embodiment, one kind or two or more kinds of these substances may be used as the hydrogen site protecting agent.

In order to enhance plasma resistance, the content of the hydrogen site protecting agent is preferably 1 part by mass or more, and more preferably 5 parts by mass or more, and preferably 20 parts by mass or less, and more preferably 15 parts by mass or less with respect to 100 parts by mass of the rubber component.

The uncrosslinked fluororubber composition may be prepared using an open rubber mixer, such as an open roll, or a closed rubber mixer, such as a kneader. Among these mixers, the open rubber mixer such as an open roll, in particular, provides excellent processability in kneading.

Processing using a mold, for example, is performed to form an article such as a seal material from the fluororubber composition described above. That is, a cavity of a preheated mold is filled with a predetermined amount of an uncrosslinked fluororubber composition according to the present embodiment, and the mold is clamped. In this state, the mold is held for a predetermined molding time under a predetermined molding temperature and a predetermined molding pressure. While in this period, the uncrosslinked fluororubber composition is formed into the shape of the cavity, and the rubber component is crosslinked by the crosslinking agent and loses the plasticity. The molding may be press molding or injection molding. The molding temperature is, for example, 150° C. or more and 180° C. or less. The molding pressure is, for example, 0.1 MPa or more and 25 MPa or less. The molding time is, for example, 3 minutes or more and 20 minutes or less. Then, the mold is opened, and the molded object is taken out of the mold and is cooled. The rubber product can be obtained in this manner. The molded object taken out of the mold may be subjected to further heat treatment under a heating temperature of 150° C. or more and 250° C. or less for a heating time of 2 hours or more and 24 hours or less.

Also in the case of using silicone rubber, the seal material can be manufactured in the same manner as in the case of using the fluororubber, although detailed conditions and the like are not necessarily the same.

The seal material manufactured in the manner described above can be used for imparting airtightness to mechanical devices. In particular, the seal material can be used under conditions of high temperature and high pressure, and can be effectively used in semiconductor manufacturing devices and the like.

### EXAMPLES

The following describes the elastomer composition and the seal material for use in a semiconductor manufacturing device according to the present disclosure with reference to Examples 1 to 7 and Comparative Examples 1 to 15. Formulations and properties are shown in Tables 1 to 3.

### Production of Seal Material of Elastomer Composition

### Example 1

To 100 parts by mass of FKM (trade name: Tecnoflon P959, manufactured by Solvay) as a fluororubber component, 1.5 parts by mass of an organic peroxide (trade name: PERHEXA 25B, manufactured by NOF Corporation) as a crosslinking agent, 2.5 parts by mass of triallyl isocyanurate (TAIC, manufactured by Mitsubishi Chemical Corporation) as a crosslinking aid, 5 parts by mass of phenol resin powder (trade name: BellPearl R100, manufactured by Air Water Bellpearl Inc.), and 5 parts by mass of silica (trade name: AEROSIL R972, manufactured by NIPPON AEROSIL CO., LTD.) were added. The resultant was kneaded with an open roll. The kneaded compound was press-molded at 160° C. for 10 minutes. Thereafter, secondary crosslinking was performed in a gear oven at 200° C. for 4 hours. The resultant seal material was taken as a seal material of Example 1. The average particle size of BellPearl R100 is 1.5 µm.

### Example 2

A seal material of Example 2 was produced in the same manner as in Example 1, except that the amount of phenol resin powder (BellPearl R100) blended and the amount of silica (AEROSIL R972) blended were both 10 parts by mass (relative to 100 parts by mass of the fluororubber; hereinafter, parts of compound ingredients by mass may sometimes be shown without describing that they are values relative to 100 parts by mass of the rubber component).

### Example 3

A seal material of Example 3 was produced in the same manner as in Example 1, except that the amount of phenol resin powder (BellPearl R100) blended was 25 parts by mass, and the amount of silica (AEROSIL R972) blended was 5 parts by mass.

### Example 4

A seal material of Example 4 was produced in the same manner as in Example 1, except that the amount of phenol resin powder (BellPearl R100) blended was 5 parts by mass, and the amount of silica (AEROSIL R972) blended was 25 parts by mass.

### Example 5

A seal material of Example 5 was produced in the same manner as in Example 1, except that the amount of phenol resin powder (BellPearl R100) blended and the amount of silica (AEROSIL R972) blended were both 25 parts by mass.

### Example 6

To 100 parts by mass of FKM (trade name: Viton A-50, manufactured by The Chemours Company) as a fluororubber component, 2.5 parts by mass of a crosslinking agent and a catalyst (trade name: Curative V-50, manufactured by The Chemours Company), 3 parts by mass of magnesium oxide (trade name: Kyowamag 150, manufactured by Kyowa Chemical Industry Co., Ltd.) as an acid acceptor, 6 parts by mass of calcium hydroxide (trade name: CALVIT, manufactured by Ohmi Chemical Industry Co., Ltd.) as an acid acceptor, 10 parts by mass of phenol resin powder (BellPearl R100), and 10 parts by mass of silica (AEROSIL R972) were added. The resultant was kneaded with an open roll. The kneaded compound was press-molded at 160° C. for 20 minutes. Thereafter, secondary crosslinking was performed in a gear oven at 250° C. for 24 hours. The resultant seal material was taken as a seal material of Example 6.

### Example 7

To 100 parts by mass of VMQ (trade name: KE-961T-U, manufactured by Shin-Etsu Chemical Co., Ltd., VMQ contains 25 parts of silica) as a silicone rubber component, 2 parts by mass of organic peroxide (trade name: C-8, manufactured by Shin-Etsu Chemical Co., Ltd.) as a crosslinking agent and 10 parts by mass of phenol resin powder (BellPearl R100) were added. The resultant was kneaded with an open roll. The kneaded compound was press-molded at 160° C. for 10 minutes. Thereafter, secondary crosslinking was performed in a gear oven at 200° C. for 4 hours. The resultant seal material was taken as a seal material of Example 7.

The content of the silica in VMQ was calculated by taking the weight of the silica as a residue obtained by thermal decomposition of silicone rubber under a nitrogen atmosphere as a content ratio.

### Comparative Example 1

A seal material of Comparative Example 1 was produced in the same manner as in Example 1, except that the amount of phenol resin powder (BellPearl R100) blended and the amount of silica (AEROSIL R972) were both 0 parts by mass (i.e., the phenol resin powder and the silica were not added).

### Comparative Example 2

A seal material of Comparative Example 2 was produced in the same manner as Comparative Example 1, except that the amount of phenol resin powder (BellPearl R100) blended was 10 parts by mass.

### Comparative Example 3

A seal material of Comparative Example 3 was produced in the same manner as in Comparative Example 1, except that the amount of phenol resin powder (BellPearl R100) blended was 25 parts by mass.

### Comparative Example 4

A seal material of Comparative Example 4 was produced in the same manner as in Comparative Example 1, except that the amount of phenol resin powder (BellPearl R100) blended was 50 parts by mass.

### Comparative Example 5

A seal material of Comparative Example 5 was produced in the same manner as in Comparative Example 2, except that BellPearl R800 (trade name, manufactured by Air Water Bellpearl Inc.) was used as a phenol resin powder in place of BellPearl R100. The average particle size of BellPearl R800 is 22 µm.

### Comparative Example 6

A seal material of Comparative Example 6 was produced in the same manner as in Comparative Example 1, except that the amount of silica (AEROSIL R972) blended was 10 parts by mass.

### Comparative Example 7

A seal material of Comparative Example 7 was produced in the same manner as in Comparative Example 1, except that the amount of silica (AEROSIL R972) blended was 25 parts by mass.

### Comparative Example 8

A seal material of Comparative Example 8 was tried to be produced in the same manner as in Comparative Example 1, except that the amount of silica (AEROSIL R972) blended was 25 parts by mass. However, when about 40 parts by mass of silica were added, roll kneading became impossible, and thus, the product could not be obtained.

### Comparative Example 9

A seal material of Comparative Example 9 was produced in the same manner as in Comparative Example 1, except that 25 parts by mass of carbon black (trade name: Thermax N990, manufactured by Cancarb Limited) was further added.

### Comparative Example 10

A seal material of Comparative Example 10 was produced in the same manner as in Comparative Example 1, except that 10 parts by mass of carbon black (Thermax N990) and 10 parts by mass of phenol resin powder (BellPearl R100) were further added.

### Comparative Example 11

A seal material of Comparative Example 11 was produced in the same manner as in Comparative Example 1, except that 10 parts by mass of carbon black (Thermax N990) and 10 parts by mass of silica (AEROSIL R972) were further added.

### Comparative Example 12

A seal material of Comparative Example 12 was produced in the same manner as in Example 6, except that the amount of phenol resin powder (BellPearl R100) blended and the amount of silica (AEROSIL R972) blended were both 0 parts by mass (i.e., the phenol resin powder and the silica were not added).

### Comparative Example 13

A seal material of Comparative Example 13 was produced in the same manner as in Comparative Example 12, except that the amount of phenol resin powder (BellPearl R100) blended was 10 parts by mass.

### Comparative Example 14

A seal material of Comparative Example 14 was produced in the same manner as in Comparative Example 12, except that the amount of silica (AEROSIL R972) blended was 10 parts by mass.

### Comparative Example 15

A seal material of Comparative Example 15 was produced in the same manner as in Example 7, except that the amount of phenol resin powder (BellPearl R100) blended was 0 parts by mass (i.e., the phenol resin powder was not added).

### Test Evaluation Method

### Hardness

The hardness of the seal material produced was measured as an instantaneous value by means of a type A durometer in accordance with JIS K6253-3.

### Tensile Strength, Elongation, 100% Modulus

The tensile strength, elongation, and 100% modulus of the seal material produced were measured using a No. 3 dumbbell-shaped test piece having a thickness of 2 mm based on JIS K6252.

### Compression Set

The compression set of the seal material produced was measured based on JIS K6262, using a test piece obtained by cutting an AS-214 O-ring in half. The heating conditions were 150° C. and 72 hours for Example 5 and Comparative Example 15, and 200° C. and 72 hours for other Examples and Comparative Examples. The compressibility ratio was 25%.

### Resistance to Compression Fracture

Measurement of resistance to compression fracture for each of the seal materials produced was performed in the same manner as in the measurement of compression set except that the compressibility ratio was 50%, and the heating conditions were 180° C. and 4 hours. The measurement was performed on three test pieces for each seal material, and the number of test pieces with no cracking was recorded.

### Test Evaluation Results

TABLE 1

| | | Examples | | | | | Comparative Examples | | | | | | | | | | |
|---|---|---|---|---|---|---|---|---|---|---|---|---|---|---|---|---|---|
| | | 1 | 2 | 3 | 4 | 5 | 1 | 2 | 3 | 4 | 5 | 6 | 7 | 8 | 9 | 10 | 11 |
| Base Rubber | FKM (Tecnoflon P959) | 100 | 100 | 100 | 100 | 100 | 100 | 100 | 100 | 100 | 100 | 100 | 100 | 100 | 100 | 100 | 100 |
| Crosslinking Agent | Organic Peroxide (PERHEXA 25B) | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 | 1.5 |
| Crosslinking Aid | Polyfunctional Compound (TAIC) | 2 | 2 | 2 | 2 | 2 | 2 | 2 | 2 | 2 | 2 | 2 | 2 | 2 | 2 | 2 | 2 |
| Filler | Phenol Resin (BellPearl R100) Phenol Resin (BellPearl R800) | 5 | 10 | 25 | 5 | 25 | - | 10 | 25 | 50 | - | - | - | - | - | 10 | - |
| | | - | - | - | - | - | - | - | - | - | 10 | - | - | - | - | - | - |
| | Carbon Black (Thermax N990) | - | - | - | - | - | - | - | - | - | - | - | - | - | 25 | 10 | 10 |
| | Silica | 5 | 10 | 5 | 25 | 25 | - | - | - | - | 10 | 10 | 25 | 50 | - | - | 10 |
| Ordinary Physical Properties | Hardness (Type-A) | 66 | 74 | 73 | 84 | 92 | 51 | 58 | 69 | 85 | 67 | 65 | 83 | Unproducible | 68 | 64 | 70 |
| | Tensile Strength (MPa) | 20.3 | 21.5 | 24.3 | 23.5 | 22.4 | 8.9 | 14.5 | 20.3 | 20.6 | 15.1 | 20.3 | 23.2 | | 24.2 | 21.5 | 19.8 |
| | Elongation (%) | 280 | 210 | 190 | 250 | 110 | 290 | 210 | 190 | 120 | 230 | 270 | 230 | | 260 | 200 | 250 |
| | 100% Modulus (Mpa) | 3.9 | 6.0 | 8.3 | 8.6 | 20.9 | 1.3 | 2.8 | 7.5 | 17.2 | 3.9 | 3.7 | 8.4 | | 5.6 | 5.1 | 4.5 |
| Heat Resistance | Compression Set (%) | 15 | 18 | 23 | 30 | 35 | 27 | 13 | 17 | 24 | Broken | 36 | 40 | | 25 | 13 | 37 |
| Resistance to Compression Fracture | The Number of Test Pieces having No Compression Crack | 3 | 3 | 3 | 3 | 3 | 0 | 1 | 2 | 2 | 0 | 1 | 1 | | 1 | 2 | 1 |

Table 1 shows the formulations of the elastomer compositions and test evaluation results for the seal materials of Examples 1 to 5 and Comparative Examples 1 to 11.

In Examples 1 to 5, no compression fracture occurred (the number of test pieces having no compression fracture was three after the test conducted three times). In contrast, in Comparative Examples 1 to 11, at least one test piece had a compression fracture. This demonstrates that the phenol resin and the silica blended together improves the resistance to compression fracture.

Comparative Example 1 does not contain phenol resin and silica. The three test pieces were cracked by the test of the resistance to compression fracture, and had low resistance to compression fracture.

In Comparative Examples 2 to 4 containing only phenol resin, there was a tendency that the resistance to compression fracture is improved by increasing the amount of the phenol resin blended. However, even Comparative Example 4 where the amount blended is 50 parts by mass, cracking occurred in one test out of three. In contrast, in Example 1 where the total amount of the phenol resin and the silica blended was 10 parts by mass, cracking was prevented. As can be seen from above, the resistance to compression fracture cannot be improved enough by simply increasing the amount of phenol resin blended, and the effect is exhibited by using both phenol resin and silica.

In Comparative Examples 6 and 7 containing only silica blended, the resistance to compression fracture was slightly improved as compared with the case (Comparative Example 1) containing neither phenol resin nor silica. However, cracking occurred in two tests out of three, which is not effective enough. Further, it was impossible to produce a seal material in the case where the amount of the silica blended was 50 parts by mass, as in Example 8.

The compression set was 36% in Comparative Example 6, whereas 18% in Example 2. In the Example and the Comparative Example, the amount of silica blended was the same. Thus, it is demonstrated that the compression set is improved by blending phenol resin. A comparison between Comparative Example 7 and Example 4 showed the same. The compression set tends to deteriorate when silica is blended, but the deterioration is reduced by further blending phenol resin.

Comparative Examples 9 to 11 contain carbon black blended. The resistance to compression fracture was slightly improved (compared with Comparative Example 1), but was insufficient. In Comparative Example 10 containing phenol resin blended, the resistance to compression fracture was superior to Comparative Example 9 or 11, but inferior to Examples.

In Comparative Examples 9 to 11, the tensile strength was around 20, which was a desirable value. Also in Examples 1 to 5, the tensile strength was 20 or more. In other words, in the case of blending, as a filler, both phenol resin and silica, the same effect of the tensile strength as the case of blending, as a commonly used filler, carbon black is obtained. Accordingly, the resistance to compression fracture can be improved without deteriorating tensile strength.

Comparative Example 5 is only different from Example 2 in the average particle size of the phenol resin. The average particle size of the phenol resin was about 1.5 µm in Example 2, and was about 22 µm in Comparative Example 5. In Comparative Example 5, the test piece was broken in the test of the compression set and cracked in all three tests of the resistance to compression fracture. This means that there is a desired range for the average particle size of the phenol resin.

Although not shown in Table 1 as an Example, the improvement in the resistance to compression fracture was demonstrated also in the case of using phenol resin powder (trade name: BellPearl R200, manufactured by AIR WATER BELLPEARL INC) with an average particle size of about 5.8 µm.

TABLE 2

| | | Example | Comparative Examples | | |
|---|---|---|---|---|---|
| | | 6 | 12 | 13 | 14 |
| Polymer | FKM (Viton A-50) | 100 | 100 | 100 | 100 |
| Crosslinking Agent | Polyol (Curative V50) | 2.5 | 2.5 | 2.5 | 2.5 |
| Acid Acceptor | Magnesium Oxide (Kyowamag 150) | 3 | 3 | 3 | 3 |
| | Calcium Hydroxide (CALVIT) | 6 | 6 | 6 | 6 |
| Filler | Phenol Resin (BellPearl R100) | 10 | - | 10 | - |
| | Silica (AEROSIL R972) | 10 | - | - | 10 |
| Ordinary Physical Properties | Hardness (Type-A) | 77 | 56 | 64 | 73 |
| | Tensile Strength (MPa) | 13.2 | 8.2 | 10.5 | 15.1 |
| | Elongation (%) | 240 | 290 | 250 | 240 |
| | 100% Modulus (MPa) | 5.6 | 1.8 | 2.8 | 4.7 |
| Heat Resistance | Compression Set | 21 | 19 | 20 | 28 |
| Resistance to Compression Fracture | The Number of Test Pieces having No Compression Crack | 3 | 0 | 1 | 1 |

Table 2 shows the formulations of the elastomer compositions and test evaluation results for the seal materials of Example 6 and Comparative Examples 12 to 14. Example 6 and Comparative Examples 12 to 14 use fluororubber of polyol crosslinking.

In Example 6 containing both the phenol resin and the silica blended, no cracking occurred in the test of resistance to compression fracture. In contract, in Comparative Examples 12 to 14 containing one or both of the phenol resin and the silica blended, cracking occurred.

As can be seen from the results of the Example and the Comparative Examples, the resistance to compression fracture improves by blending both phenol resin and silica even in the case of using fluororubber of polyol crosslinking.

TABLE 3

| | | Example | Comparative Example |
|---|---|---|---|
| | | 7 | 15 |
| Base Rubber | VMQ (KE-961T-U) | 100 | 100 |
| Crosslinking Agent | Organic Peroxide (C-8) | 2 | 2 |
| Filler | Phenol Resin (BellPearl R100) | 10 | - |
| Ordinary Physical Properties | Hardness (Type-A) | 65 | 57 |
| | Tensile Strength (MPa) | 8.4 | 8.1 |
| | Elongation (%) | 230 | 393.8 |
| | 100% Modulus (MPa) | 2.9 | 2.3 |
| Heat Resistance | Compression Set | 21 | 14 |
| Resistance to Compression Fracture | The Number of Test Pieces having No Compression Crack | 3 | 2 |

Table 3 shows the formulations of the elastomer compositions and test evaluation results for the seal materials of Example 7 and Comparative Example 15. Example 7 and Comparative Example 15 use silicone rubber. Although not directly shown in Table 3, silicone rubber used contained silica. That is, Example 7 and Comparative Example 15 both contain silica, and are different from each other in the phenol resin contained or not contained.

In Example 7, no cracking occurred in the test of resistance to compression fracture. In contrast, in Comparative Example 15, cracking occurred in one test out of three. As can be seen from above, the resistance to compression fracture improves by blending both phenol resin and silica even in the case of using silicone rubber.

### INDUSTRIAL APPLICABILITY

The elastomer composition and the seal material according to the present disclosure have excellent properties such as a compression fracture property and compression set, and are thus useful for the use under conditions in which these properties are strictly required. Further, the elastomer composition according to the present disclosure has excellent properties such as a compression fracture property and compression set, and thus is useful for the use by molding into a hose, a tube, a transport pad, and a transport roller.

1. An elastomer composition comprising:
an elastomer;
a phenol resin in powder form; and
silica in powder form.

2. The elastomer composition of claim 1, wherein:
the elastomer at least includes a fluorine elastomer or a silicone elastomer.

3. The elastomer composition of claim 1, wherein:
the elastomer is a fluorine elastomer.

4. The elastomer composition of claim 1, wherein
the phenol resin has a particle diameter of 20 µm or less.

5. The elastomer composition of claim 1, wherein:
an amount of the phenol resin blended and an amount of the silica blended relative to 100 parts by mass of the elastomer are each 1 part by mass or more and 30 parts by mass or less.

6. A seal material obtained by crosslinking and molding the elastomer composition of claim 1.

7. A seal material for use in a semiconductor manufacturing device, obtained by crosslinking and molding the elastomer composition of claim 1.
